(19) United States
(12) Patent Application Publication
(10) Pub. No.: US 2006/0074886 A1
(43) Pub. Date: Apr. 6, 2006

(54) Multi-level query system and method

(75) Inventors: Anthony Zhou, Taipei (TW); Chaucer Chiu, Taipei (TW)

Correspondence Address: EITAN, PEARL, LATZER & COHEN ZEDEK LLP, 10 ROCKEFELLER PLAZA, SUITE 1001, NEW YORK, NY, 10020, US

(73) Assignee: INVENTEC CORPORATION

(21) Appl. No.: 11/016,935

(22) Filed: Dec. 21, 2004

(30) Foreign Application Priority Data
Oct. 1, 2004 (TW) 093129799

(51) Int. Cl. G06F 17/30

(52) U.S. Cl. 707/3

(57) ABSTRACT

A multi-level query system and method can be applied to an information device to perform lookup and translation of a vocabulary of a foreign language. Firstly, a vocabulary to be inquired and translated is inputted via a screen of the information device to the system. Then, the system determines whether there is enough space for storing content from query of the vocabulary, and adjusts an assigned storage node according to the determination result so as to record an assignment condition of the storage node. Subsequently, the system stores the inputted vocabulary and assigns it to a corresponding position according to the storage node as well as displays a definition of the vocabulary. This can achieve multi-level query of continuous chains of vocabularies of a foreign language and also allow the query results to be switched between different levels.

### RELATED APPLICATION DATA

The present application claims priority from prior Taiwanese application 093129799 filed Oct. 1, 2004, incorporated by reference herein in its entirety.

### FIELD OF THE INVENTION

The present invention relates to language vocabulary query technologies, and more particularly, to a multi-level query system and method for providing an instant dictionary and instant translation to inquire and translate vocabularies of a foreign language inputted via a keyboard and a mouse of an information device.

### BACKGROUND OF THE INVENTION

In today's world with excessive exchange of cultural and economical information between countries, learning foreign advanced technologies has become essential to accelerate the development of domestic knowledge base. However, at present, in order to learn foreign culture and technology, it is important to be able to research, understand and extend foreign information documents, which require conquering different language barriers and opening a communication path between countries.

Therefore, the provision of dictionaries provides users with a powerful tool to overcome the reading barrier caused by foreign languages. However, the number of vocabularies and the convenience of using the dictionary have an inverse relationship to each other. In other words, the more vocabularies contained in the dictionary, the thicker and heavier and harder to read the dictionary is. On the other hand, generally the lighter the dictionary, the more limited number of vocabularies the dictionary contains.

Along with the rapid development of electronic technology, an electronic dictionary gradually replaces the traditional dictionary and becomes a mainstream product. The electronic dictionary has much greater vocabulary capacity than the traditional dictionary, making the electronic dictionary have strong usability and widely applied in various electronic devices. For example, the electronic dictionary can be combined with a computer, PDA (personal digital assistant) and mobile communication device to demonstrate the great functions of the electronic dictionary.

However, the conventional electronic dictionary still has some drawbacks. For example, when the user tries to look up the meaning of one unknown word, the definition of this word may contain another unknown word and cause the user not able to fully understand this definition. Moreover, in the case of a word having different spellings in British English and in American English, the dictionary often only provides a detailed definition for the word with one of the spellings, and allows the other spelling to have reference to the former one. For example, the word “colour” in British English is spelled as “color” in American English, and the conventional electronic dictionary normally gives a definition of “colour” as “[English]=color”. Such definition is acceptable for a person who already knows what the word “color” means, but does not give an appropriate answer for a person who does not understand the meaning of “color” and seeks to inquire the word “colour”.

In addition, there has been proposed another kind of electronic dictionary, which uses easy and simple words or more frequently used words to define harder or rarely used vocabularies. However, when the user uses this electronic dictionary to inquire an unknown vocabulary, if the definition provided for the inquired vocabulary still contain unknown words for the user, this would make the query process impeded and fail.

Therefore, the problem to be solved here is to provide a query system and method for providing an instant dictionary and instant translation via an information device to inquire and translate vocabularies of a foreign language, so as to resolve the above drawbacks in the prior art and realize multi-level query of continuous chains of foreign vocabularies, as well as allow the query results to be switched between different levels.

### SUMMARY OF THE INVENTION

In light of the above drawbacks in the prior art, an objective of the present invention is to provide a multi-level query system and method so as to achieve query of continuous chains of vocabularies of a foreign language.

Another objective of the present invention is to provide a multi-level query system and method for allowing the query results to be switched between different levels.

A further objective of the present invention is to provide a multi-level query system and method for allowing a user to input a word in query via a keyboard or operate a mouse to select the word in query from a screen, such that instant input of the word and instant inquiry of its meaning can be achieved, thereby increasing convenience of use for the user.

In order to achieve the above and other objectives, the present invention proposes a multi-level query system and method.

The multi-level query system comprises an input module for selecting and retrieving a vocabulary; a storage unit for storing content of definition and translation of the vocabulary; a detecting module for examining a usage condition of the storage unit and determining whether there is enough space in the storage unit for storing the content from query of the vocabulary; a node assignment module for assigning a storage node to the selected vocabulary and adjusting the assigned storage node according to the determination result of the detecting module; and a node recording module for recording a message of the assigned storage node adjusted by the node assignment module.

The multi-level query method according to the present invention is performed through the above multi-level query system. The multi-level query method comprises the steps of: (1) providing a query interface via a screen of an information device for a user to operate, wherein the query interface comprises a toolbar, a vocabulary selection display frame, a classified vocabulary index section, and a vocabulary definition/translation section; (2) allowing the user to operate a mouse (for example by double clicking the mouse, moving a cursor of the mouse to a vocabulary, or pressing a right button of the mouse) to select a vocabulary in query from the vocabulary definition/translation section, or directly input the vocabulary in query via a keyboard to the vocabulary selection display frame; (3) allowing the detecting module to examine a usage condition of the storage unit and determine whether there is enough space in the storage unit for storing content from query of the vocabulary; (4) allowing the node assignment module to assign a storage node to the vocabulary and adjust the assigned storage node according to the determination result of the detecting module; (5) storing the vocabulary in query in the storage unit, and assigning the storage node for the vocabulary to a corresponding position via the node assignment module; and (6) recording an assigning condition of the storage node in the node recording module, and displaying the query result of definition and translation of the vocabulary in the vocabulary definition/translation section.

Compared to the conventional vocabulary inquiry technology, the query system and method in the present invention can achieve multi-level query of continuous chains of vocabularies, and also allow the query results to be switched between different levels. The query system and method further allow a user to instantly retrieve a vocabulary by for example double clicking a mouse, moving a cursor of the mouse to the vocabulary or pressing a right button of the mouse, etc. according to an operating mode set by the user to instantly look up the vocabulary. This can eliminate the drawbacks in the prior art and make the query process to progress easily.

### BRIED DESCRIPTION OF THE DRAWINGS

The present invention can be more fully understood by reading the following detailed description of the preferred embodiments, with reference made to the accompanying drawings, wherein:

FIG. 1 is a block diagram showing basic architecture of a multi-level query system according to the present invention;

FIG. 2 is a flowchart showing the steps of a multi-level query method according to the present invention;

FIG. 3 is a flowchart showing the steps of performing query on continuous chains of vocabularies in the use of the multi-level query method according to the present invention;

FIG. 4 is a flowchart showing the steps of returning to a query level in the use of the multi-level query method according to the present invention;

FIG. 5a is a schematic diagram of a query interface showing a user to obtain the lowest level of query of a vocabulary “colour” by entering the vocabulary via a keyboard or selecting via a mouse the vocabulary located at any position on a screen of a computer; and

FIG. 5b is a schematic diagram of a query interface showing the user to perform the next level of query of a word “color” by double clicking the mouse on the word.

### DETAILED DESCRIPTION OF THE PREFFERED EMBODIMENT

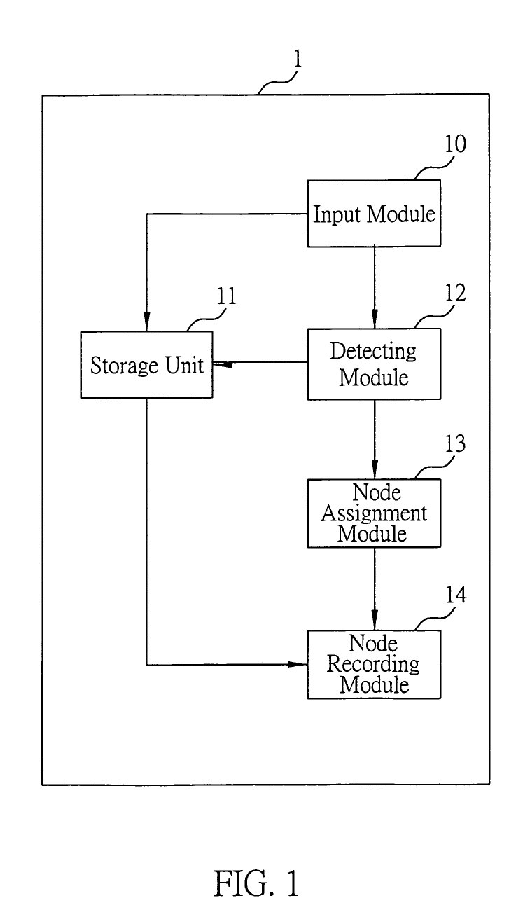

FIG. 1 is a block diagram showing basic architecture of a multi-level query system according to the present invention. The multi-level query system 1 comprises an input module 10, a storage unit 11, a detecting module 12, a node assignment module 13, and a node recording module 14.

In this embodiment, the multi-level query system 1 further comprises a screen of an information device (not shown, such as a desktop computer, notebook computer, or PDA, etc.) to display a query interface for a user to perform instant query and translation of a vocabulary of a foreign language via the query interface. The query interface comprises a toolbar, a vocabulary selection display frame, a classified vocabulary index section, and a vocabulary definition/translation section. This allows the user to in advance select the type of language for the vocabulary to be inquired from the classified vocabulary index section.

The input module 10 allows the vocabulary to be selected and retrieved. The input module 10 can be a keyboard or mouse connected to the information device, such that the vocabulary can be selected from the vocabulary definition/translation section of the query interface via operating the mouse or inputted to vocabulary selection display frame via operating the keyboard.

The storage unit 11 is used to store content of definition and translation of the inquired vocabulary. It is to be noted that, the storage unit 11 in the present invention stores the content according to characteristics of vocabularies and the user's query activity, and assigns its memory capacity to store vocabularies of different levels in corresponding positions therein.

The detecting module 12 is used to examine a usage condition of the storage unit 11 and thus determine whether there is enough space in the storage unit 11 for storing the content of current query of the vocabulary.

The node assignment module 13 serves to assign a storage node to the inquired vocabulary and adjust the assigned storage node according to the determination result of the detecting module 12. In this embodiment, particularly unlimited level continuous query can be performed on continuous chains of vocabularies. If the memory capacity is sufficient, all the query results of different levels are assigned to a storage node by the node assignment module 13 so as to record the content of vocabulary query of the current level. On the other hand, if there is no sufficient memory capacity, the record of the second last level is erased, and nodes of the second last level are considered as nodes of the latest level to store the content of current query of the vocabulary. The node at the first or beginning level always remains intact. As a result, the above node adjusting process can be performed to allow the user to be able to return to the inquired vocabulary of the first level any time.

The node recording module 14 is used to record a message of the storage node adjusted by the node assignment module 13.

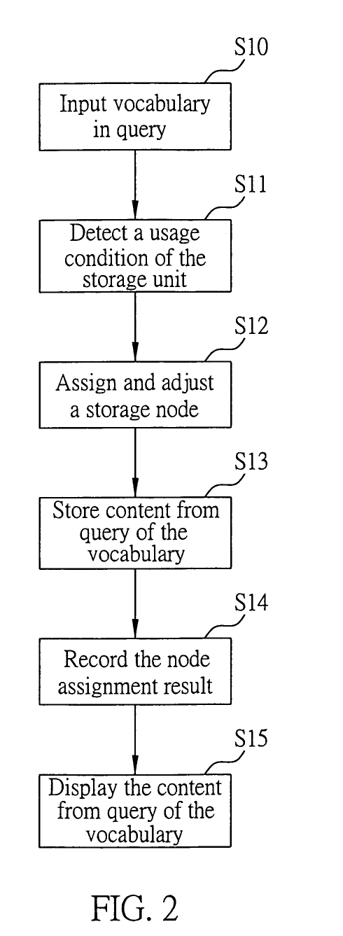

FIG. 2 is a flowchart showing the steps of a multi-level query method through the use of the above multi-level query system 1 according to the present invention.

In step S10, first, a vocabulary is selected and retrieved by a user via the input module 10. Then, the method proceeds to step S11.

In step S11, the detecting module 12 examines a usage condition of the store unit 11 and determines whether the store unit 11 has enough space for storing content from query of the vocabulary. Then, the method proceeds to step S12.

In step S12, the node assignment module 13 assigns a storage node to the selected vocabulary and adjusts the assigned storage node according to the determination result of the detecting module 12. Then, the method proceeds to step S13.

In step S13, the selected vocabulary is stored in the storage unit 11, and the storage node for the selected vocabulary is assigned to a corresponding position by the node assignment module 13. Then, the method proceeds to step S14.

In step S14, an assignment condition of the adjusted storage node is recorded in the node recording module 14. Then, the method proceeds to step S15.

In step S15, the user is allowed to select any level of the content from query of the vocabulary stored in the corresponding node of the storage unit 11, and display a definition corresponding to the selected vocabulary.

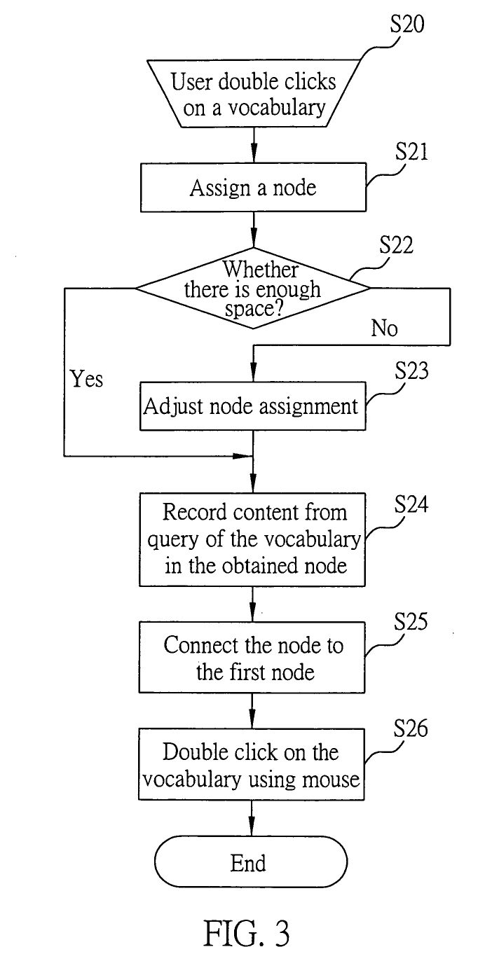

FIG. 3 is a flowchart showing the steps of performing query on continuous chains of vocabularies in the use of the multi-level query method according to the present invention.

As shown in FIG. 3, in step S20, a vocabulary of a foreign language to be inquired is selected on a screen by a user operating a mouse (such as double clicking the mouse, moving a cursor of the mouse to the vocabulary, or pressing a right button of the mouse). Then, it proceeds to step S21.

In step S21, the node assignment module 13 assigns a storage node to the selected vocabulary of the foreign language. Then, it proceeds to step S22.

In step S22, the detecting module 12 determines whether the storage unit 11 has enough space for storing a definition of the selected vocabulary of the foreign language. If no, it proceeds to step S23; if yes, it proceeds to step S24.

In step S23, the node assignment is adjusted to obtain the second last node of a query level and connect the last node and the third last node together. Then, it proceeds to step S24.

In step S24, after adjusting the node assignment and retrieving a node position of the second last node, the content of definition from current query of the vocabulary is recorded. Then, it proceeds to step S25.

In step S25, the second last node is connected to the first node of the query level. Then, it proceeds to step S26.

In step S26, query is performed on the vocabulary selected via the mouse from the screen, and the query result is displayed on the user's operating interface.

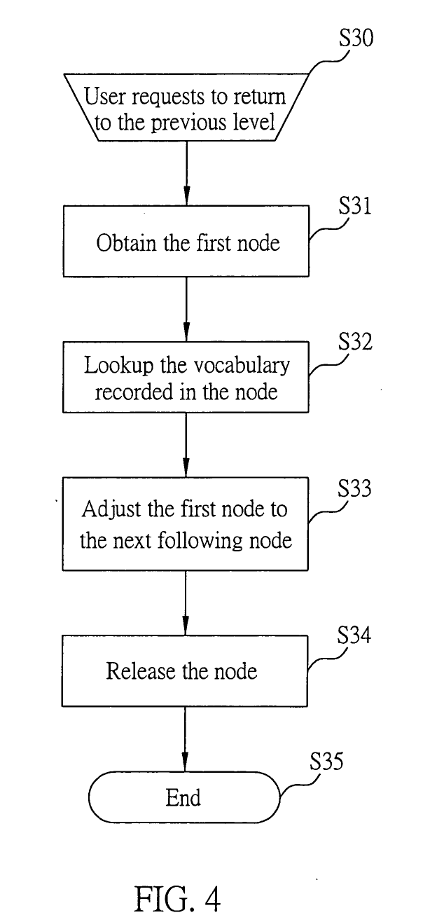

FIG. 4 is flowchart showing the steps of returning to a query level in the use of the multi-level query method according to the present invention.

In step S30, the user requests to return to the previous query level. Then, it proceeds to step S31.

In step S31, the first node of the query level is obtained. Then, it proceeds to step S32.

In step S32, query is performed on vocabulary content recorded in the first node. Then, it proceeds to step S33.

In step S33, the first node of the query level is adjusted to be the next following node. Finally, it proceeds to S34.

In step S34, the node is released.

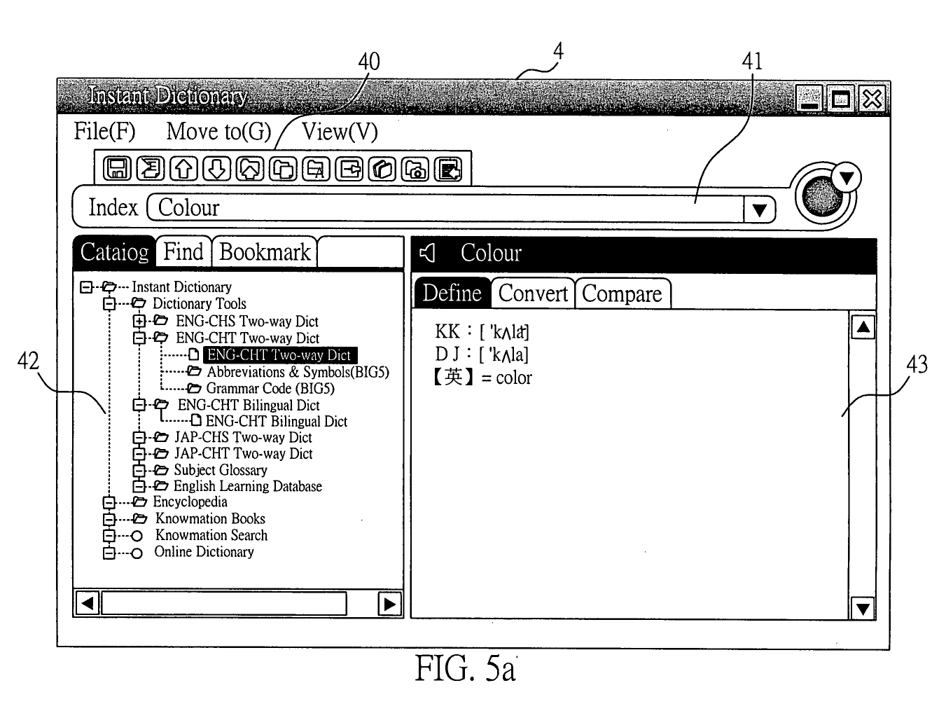

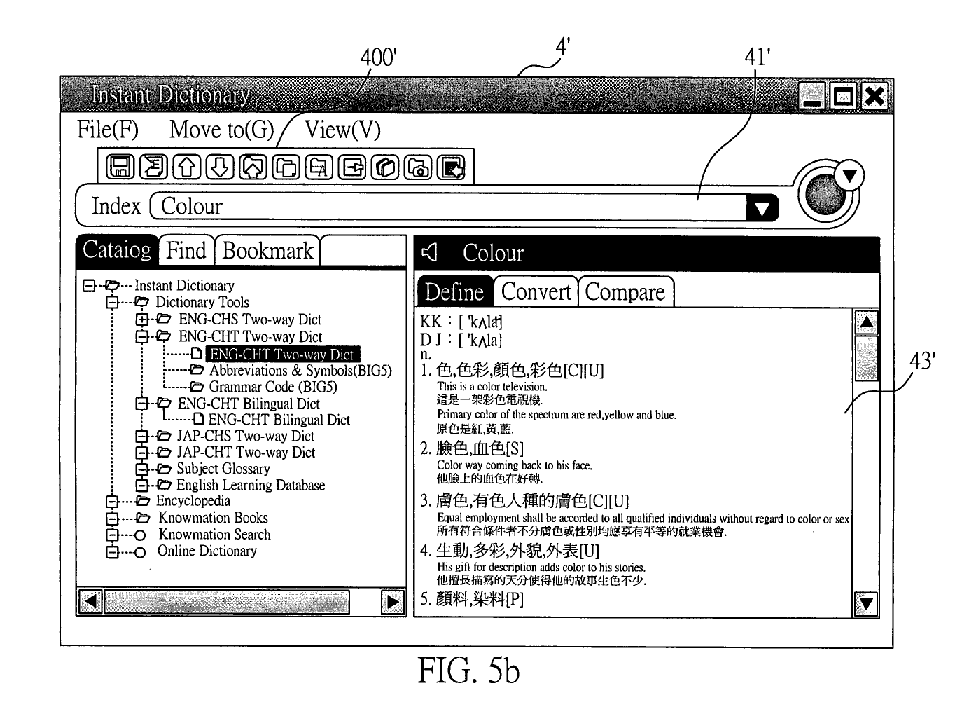

FIGS. 5a and 5b show a query interface of the multi-level query system according to the present invention being displayed on the information device. It should be noted that, in order to clarify the multi-level query system and method in the present invention, a scenario of query of a vocabulary “colour” is exemplified.

FIG. 5a shows the query interface 4 being displayed when a user inputs a vocabulary “colour” via the input module 10 to the lowest query level. As shown in FIG. 5a, the query interface 4 comprises a toolbar 40, a vocabulary selection display frame 41, a classified vocabulary index section 42, and a vocabulary definition/translation display section 43. The vocabulary selection display frame 41 is used to display the current vocabulary such as “colour” inputted by the user. For example, the methods for the user to input the vocabulary “colour” via the input module 10 to the lowest query level comprises: entering the vocabulary “colour” directly via a keyboard in the vocabulary selection display frame 41, and during computer information processing, operating a mouse (such as double clicking the mouse, moving a cursor of the mouse to the vocabulary, or pressing a right button of the mouse) to select the vocabulary “colour” that may be displayed at any position on a computer screen. Then, the user needs to select a type of dictionary for query in the classified vocabulary index section 42. In this embodiment, the selected dictionary is an English Chinese Two-Way Dictionary (shown as a black-white highlighted section in the drawing). After query of the vocabulary “colour” inputted by the user is performed, an explanation of the vocabulary “colour” is displayed on the vocabulary definition/translation display section 43 as shown in the drawing that “[English]=color”. However, in case the user does not understand the word “color” in the explanation, the user can double click the mouse on the word “color” in the vocabulary definition/translation display section 43 to perform the next level of query.

FIG. 5b shows the query interface 4′ being displayed when the user operates the mouse to perform the next level of query on the word “color”. As shown in FIG. 5b, the vocabulary to be inquired by the user in the vocabulary selection display frame 41′ has changed from “colour” to “color”, and content displayed in the vocabulary definition/translation display section 43′ corresponds to a definition of the word “color”. It should be noted that, the toolbar 40′ comprises a returning function button 400′ for returning to the query result of the previous level, such that the user can return to the query result of the previous level shown in FIG. 5a by pressing the returning function button 400′ of the toolbar 40′.

Therefore, the query system and method in the present invention can achieve multi-level query of continuous chains of vocabularies, and also allow the query results to be switch between different levels.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A multi-level query method applicable to an information device, for performing query and translation of a vocabulary of a foreign language via a multi-level query system, the multi-level query method comprising the steps of:
(1) selecting and retrieving a vocabulary via the multi-level query system;
(2) determining via the multi-level query system whether there is enough storage space for storing content from query of the vocabulary;
(3) assigning a storage node to the selected vocabulary and adjusting the assigned storage node according to the determination result via the multi-level query system;
(4) storing via the multi-level query system the selected vocabulary in a corresponding position according to the storage node for the selected vocabulary;
(5) recording via the multi-level query system an assignment condition of the node after adjustment; and
(6) inquiring via the multi-level query system a definition of the selected vocabulary.

2. The multi-level query method of claim 1, wherein the information device provides a query interface for a user to perform instant query and translation of the vocabulary of the foreign language.

3. The multi-level query method of claim 2, wherein the query interface comprises at least one of a toolbar, a vocabulary selection display frame, a classified vocabulary index section, and a vocabulary definition/translation display section.

4. The multi-level query method of claim 3, wherein the toolbar of the query interface has a function button for retrieving content of definition and translation of vocabularies contained in different storage node positions.

5. The multi-level query method of claim 3, wherein the classified vocabulary index section of the query interface provides selection of the type of foreign language for the vocabulary.

6. The multi-level query method of claim 3, wherein the user is allowed to select the vocabulary in the vocabulary definition/translation display section of the query interface via double clicking a mouse, moving a cursor of the mouse to the vocabulary, or pressing a right button of the mouse, so as to perform continuous chains of query and translation.

7. The multi-level query method of claim 3, wherein the user is allowed to use a keyboard to enter the vocabulary in the vocabulary selection display frame so as to perform query and translation of the vocabulary.

8. The multi-level query method of claim 6, wherein the continuous chains of query provides adjustment and assignment of the storage node according to memory capacity contained in the information device so as to allow the user to return to a previous level of query for the vocabulary.

9. A multi-level query system applicable to an information device, for performing query and translation of a vocabulary of a foreign language, the multi-level query system comprising:
an input module for selecting and retrieving the vocabulary;
a storage unit for storing content of definition and translation of the vocabulary;
a detecting module for examining a usage condition of the storage unit and determining whether there is enough space in the storage unit for storing content from query of the vocabulary;
a node assignment module for assigning a storage node to the vocabulary and adjusting the assigned storage node according the determination result of the detecting module; and
a node recording module for recording a message of the storage node adjusted by the node assignment module.

10. The multi-level query system of claim 9, wherein the information device provides a query interface for a user to perform instant query and translation of the vocabulary of the foreign language.

11. The multi-level query system of claim 9, wherein the input module is a mouse or keyboard connected to the information device.

12. The multi-level query system of claim 10, wherein the query interface comprises at least one of a toolbar, a vocabulary selection display frame, a classified vocabulary index section, and a vocabulary definition/translation display section.

13. The multi-level query system of claim 12, wherein the toolbar of the query interface has a function button for retrieving content of definition and translation of vocabularies contained in different storage node positions.

14. The multi-level query system of claim 12, wherein the classified vocabulary index section of the query interface provides selection of the type of foreign language for the vocabulary.

15. The multi-level query system of claim 12, wherein the user is allowed to select the vocabulary in the vocabulary definition/translation display section of the query interface via double clicking a mouse, moving a cursor of the mouse to the vocabulary, or pressing a right button of the mouse, so as to perform continuous chains of query and translation.

16. The multi-level query system of claim 12, wherein the user is allowed to use a keyboard to enter the vocabulary in the vocabulary selection display frame so as to perform query and translation of the vocabulary.

17. The multi-level query system of claim 15, wherein the continuous chains of query provides adjustment and assignment of the storage node according to memory capacity contained in the information device so as to allow the user to return to a previous level of query for the vocabulary.

18. The multi-level query system of claim 9, wherein the information device is one of a desktop computer, a notebook computer, and a PDA (personal digital assistant).
